(19) United States
(12) Patent Application Publication
(10) Pub. No.: US 2026/0274701 A1
(43) Pub. Date: Sep. 17, 2026

(54) METHOD FOR PRODUCING IRON CHLORIDE AND ALUMINUM CHLORIDE FROM SEWAGE SLUDGE ASHES

(71) Applicant: LANXESS Deutschland GmbH, Cologne (DE)

(72) Inventor: Matthias Boll, Cologne (DE)

(73) Assignee: LANXESS Deutschland GmbH, Cologne (DE)

(21) Appl. No.: 19/168,542

(22) PCT Filed: Mar. 22, 2024
(86) PCT No.: PCT/EP2024/057813

§ 371 Date: Sep. 24, 2025

(30) Foreign Application Priority Data
Mar. 28, 2023 (EP) 23164738.9

(51) Int. Cl. C01F 7/60; C01F 7/62; C01G 49/10

(52) U.S. Cl. CPC C01F 7/60; C01F 7/62; C01G 49/10

(57) ABSTRACT

Process for producing iron chloride and aluminium chloride, characterized in that it comprises
i) reacting a sewage sludge ash containing at least one iron compound and aluminium compound with at least one alkali metal chloride and/or at least one alkaline earth metal chloride at a temperature of 200° C. to 1100° C. in an inert gas atmosphere and
ii) withdrawing and isolating the formed iron chloride and aluminium chloride in the offgas stream.

The invention relates to a process for producing iron chloride and aluminium chloride from iron compounds and aluminium compounds present in sewage sludge ashes.

Iron chlorides such as Fe(II)Cl₂ and Fe(III)Cl₃ are typically produced from metallic iron. The same applies to aluminium, which is likewise produced from elemental aluminium. However, iron or aluminium-containing compounds that have not hitherto been considered as alternative sources for the production of corresponding chlorides, such as sewage sludge ashes, are becoming available in increasingly large volumes.

For some waste materials comprising iron-containing compounds, iron is a disruptive element when it comes to reutilizing the main components of these waste streams. These include in particular sewage sludge ash which is generally composed of various iron compounds to an extent of high single-digit to mid-two-digit percentages (based on elemental iron). The iron compounds generally have very poor solubility in water, thus making direct utilization uneconomic. Thus for example iron phosphate present in sewage sludge ash has very poor solubility even in relatively highly concentrated solutions of phosphoric acid, thus making it uneconomic, for example, to use phosphate fertilizers highly contaminated with iron ions.

Sewage sludge is thus available as a further source for production of iron chlorides as well as of aluminium chlorides.

The reaction of phosphates with chlorides of alkali metal and/or alkaline earth metals has been investigated repeatedly for the use case of sewage sludge ash. Sewage sludge has been mixed with various alkali metal or alkaline earth metal chlorides and heated in a dry state in air with the aim of performing the heavy metal depletion necessary for direct use of the ash in the agricultural industry.

Thus, Christian Adam et al., (Materials Transactions, Vol. 48, No. 12 (2007) pp. 3056-3061) report the dry reaction of sewage sludge ash with magnesium chloride at temperatures of up to 1000° C. in air, and according FIG. 5 find practically complete retention of the iron and aluminium components in the residue and thus no depletion of aluminium and iron.

Mattenberger et al., in Waste Management 28 (2008) 2709-2722, have conducted tests on the removal of Cd, Cr, Cu, Ni, Pb and Zn from sewage sludge ash through addition of KCl or MgCl₂ at temperatures of more than 900° C. in air and also reported no depletion of iron or aluminium.

It was accordingly an object of the present invention to provide an appropriate process proceeding from iron compounds and aluminium compounds present in sewage sludge ashes.

A process has now surprisingly been found for producing iron chlorides and aluminium chlorides that is characterized in that it comprises
i) reacting a sewage sludge ash containing at least one iron compound and aluminium compound with at least one alkali metal chloride and/or at least one alkaline earth metal chloride at a temperature of 200° C. to 1100° C. in an inert gas atmosphere containing preferably less than 200 ppm of oxygen and
ii) withdrawing and isolating the formed iron chloride and aluminium chloride in the offgas stream.

### Sewage Sludge Ash

Sewage sludge ash is preferably to be understood as meaning the solid residue generated both in sewage sludge combustion and in sewage sludge gasification for production of a fuel gas. Sewage sludge may contain various constituents, such as preferably aluminium phosphates, iron phosphates such as calcium iron phosphates, for example Ca₉Fe(PO₄)₇ or whitlockite Ca₃(PO₄)₂, gypsum, calcium hydroxides, oxides and carbonates, iron oxides such as haematites (Fe₂O₃) and quartz (SiO₂), indialites (Mg₂Al₄Si₅O₁₈), to name but a few.

The sewage sludge ash preferably contains a proportion of iron compounds of 1% to 21% by weight (calculated as elemental iron) and a proportion of aluminium compounds of 0.7% to 20.2% by weight calculated as elemental aluminium.

It is preferable when the sum of iron and aluminium compounds is from 1.7% to 41.2% by weight calculated as the respective elemental metal. The preferred composition of a sewage sludge ash contains at least one phosphate source in a proportion of at least 1% by weight based on the sewage sludge ash.

The sewage sludge ash may commonly contain further elements, as calculated for the respective element, preferably:
calcium from 4% to 38% by weight,
potassium from 0% to 2% by weight,
magnesium from 0.1% to 4% by weight,
sodium from 0.1% to 4% by weight,
phosphate PO₄³⁻ from 4% to 40% by weight,
sulfur from 0% to 7% by weight,
silicon from 0% to 24% by weight and
titanium from 0% to 2% by weight.

The elements together, calculated as oxides, preferably make up more than 70% by weight of the sewage sludge ash.

The respective components may preferably be present in the form of oxides or phosphates or sulfates. The iron compound is preferably present as an iron (III) compound to an extent of 50-100% by weight. It is preferable when 80% by weight or more of the phosphates are present as metal phosphates of aluminium, calcium or iron.

Sewage sludge ash additionally contains numerous further elements in subordinate amounts, these including especially copper, zinc, lead, barium and manganese. The aforementioned silicon is substantially in the form of sand, principally from the filtration processes customary in sewage treatment works.

### Alkali Metal Chlorides

Suitable alkali metal chlorides preferably include NaCl, KCl, LiCl and mixtures thereof. Preference is given to NaCl or KCl or a mixture of NaCl and KCl. If NaCl is used in admixture with other alkali metal chlorides, in particular with KCl, the mixture weight ratio is preferably from 10:1 to 0.1:1, in particular from 5:1 to 0.5:1.

It is preferable to employ alkali metal chloride in an amount of 1 to 5 mol, based on in each case 1 mol of the sum of the moles of iron and aluminium present, for example determined by elemental analysis.

It is preferable to employ alkali metal chloride in an amount of 5:1 to 1:1 (mol/mol) based on in each case one mole of the sum of the moles of iron and moles of aluminium present in the mixture, for example determined by elemental analysis, for example conducted by ICP-OES or ICP-MS.

### Alkaline Earth Metal Chlorides

Suitable alkaline earth metal chlorides especially include MgCl₂, CaCl₂) or mixtures thereof. MgCl₂ is preferred.

Preference is given to a mixture of alkaline earth metal chlorides and alkali metal chlorides, in particular MgCl₂ and NaCl and/or KCl in a weight ratio of 4:1 to 0.25:1, in particular from 2:1 to 0.5:1. It is particularly preferable to employ a mixture of KCl, NaCl and MgCl₂.

It is likewise preferable to employ a mixture of MgCl₂ and KCl in a weight ratio of 3:1 to 0.5:1.

### Miscellaneous

The process is preferably characterized in that the molar ratio of chlorine from the employed alkali metal chlorides and alkaline earth metal chlorides to the sum of iron and aluminium present in the mixture, calculated as metal, preferably determined by elemental analysis, for example conducted by ICP-OES or ICP-MS, is 1 to 6.

The steps of thermal reaction may optionally be preceded by briquetting, pelletizing or extruding of the sewage sludge ash, optionally with subsequent thermal pretreatment at 100° C. to 199° C., preferably as a mixture with the appropriate alkali metal and/or alkaline earth metal chlorides. Auxiliaries such as phyllosilicates such as bentonites, lignosulfonate, methylcellulose, waterglass, starch or others may be used to this end.

### Process

The input materials, the sewage sludge ash and the alkali metal chloride(s) and/or alkaline earth metal chloride(s) to be employed are preferably mixed in a mixer in dry form. Preferably employed mixers are paddle mixers or mills, for instance a ball mill. The latter have the advantage of also achieving better homogenization of the employed reactants through comminution. This is preferably followed by a shaping through briquetting, pelletizing or extruding.

It is advantageous to perform even the step of mixing the reactants in an inert gas atmosphere, preferably in the absence of water to protect any hygroscopic components present from water absorption which could have an adverse effect on process yield.

The reaction itself is preferably also carried out in the absence of air and water. Preferred inert gases preferably include nitrogen, argon or carbon dioxide. It is preferable when the inert gas atmosphere contains less than 200 ppm, in particular less than 100 ppm, of oxygen

The reaction of the sewage sludge ash containing iron compounds and aluminium compounds may be performed in a fluidized bed or dumped bed or moving bed reactor, in a shaft furnace or in a preferably gas-tight furnace, as may be conceived in the simplest form as an indirectly heated tube furnace or rotary furnace. The products formed in the reaction which are volatile at the reaction temperature, here especially iron chloride, but also aluminium chlorides and optionally further heavy metal chlorides, are preferably collectively resublimed and collected at a cold spot at temperatures below 150° C. or resublimed and collected separately at different cold spots.

In a preferred embodiment the iron chloride formed is isolated from the offgas stream by resublimation and the aluminium chloride is isolated from the offgas stream by resublimation.

Preferred deposition temperatures for FeCl₂ are less than 700° C., in particular less than 700° C. to 307° C., for FeCl₃ less than 307° C., in particular 150° C. to 300° C., and for AlCl₃ less than 150° C., in particular 110° C. to 149° C.

The iron recovered according to the invention in the form of iron (III) chloride and/or iron (II) chloride is already very pure and may then be converted into the desired raw material form of the iron. Examples here include iron sulfate, iron nitrate, iron phosphate, or the wide variety of different forms of iron oxide.

Alternatively, the iron chloride, even without having been deposited by resublimation, may be introduced directly as a gas stream into an aqueous medium containing sulfuric acid, nitric acid or phosphoric acid and thus made to form corresponding iron (III) sulfates, nitrates or phosphates. Concomitant use of a suitable reducing agent in the reaction is also possible to obtain an iron (II) sulfate, iron (II) nitrate or iron (II) phosphate.

However, it is preferable to separate iron chloride from the offgas stream by resublimation.

Alternatively, the aluminium chloride, even without having been deposited by resublimation, may be introduced directly as a gas stream into an aqueous medium containing sulfuric acid, nitric acid or phosphoric acid and thus made to form corresponding aluminium sulfates, nitrates or phosphates.

However, preference is given to separating aluminium chloride from the offgas stream by resublimation.

The residue after the reaction preferably contains phosphates of the employed alkali and/or alkaline earth metal group and possibly further phosphates, for example Ca₃(PO₄)₂.

The residue obtained is preferably treated by adding 0.1 to 5 mol of phosphoric acid per mole of phosphate, preferably 0.2 to 1 mol of phosphoric acid per mole of phosphate. The residue of the reaction can thus be converted into a water-soluble salt form which is suitable as such for use in agriculture.

### Temperature

The reaction is preferably carried out at a temperature of 400° C. to 1000° C. The reaction typically takes 5 minutes to 10 hours, preferably 2 to 5 hours.

### Use of the Residue

While natural iron phosphates are especially found in iron deposits such as pyrrhotite deposits, sewage sludge ashes containing iron phosphate compounds, for example, are generated during combustion of sewage sludge and comprise a high percentage (up to 40% by weight) of phosphate.

The sewage sludge ash is generally in the form of a mixture of different phosphates such as calcium, iron and aluminium phosphate. The precise composition/the ratio of the metal cations depends on the technology with which the sludge-producing sewage treatment plants perform the phosphate precipitation. Iron phosphate, which is very often produced during precipitation processes in sewage treatment plants, is one of the most common phosphate representatives.

One way to make the phosphate present in the sewage sludge ash available to plants is, for example, digestion with HCl or H₂SO₄, as described for example in EP 3 623 348 B1. This process employs solutions, thus resulting in poor space-time yield. Numerous chemicals are employed, such as various alkalis, acids and limewater, thus complicating and increasing the cost of the process. Filtration steps such as those of iron hydroxide and aluminium hydroxide are technically complex and thus costly. At the same time, large amounts of waste are formed since the employed chloride from the HCl cannot be discharged as a product.

Thermal processes are also mentioned, for example Christian Adam et al. (Materials Transactions, vol. 48, no. 12 (2007) pp. 3056-3061).

The invention therefore also relates to a process for producing water-soluble phosphate compounds having a water solubility at 20° C. of greater than 1 g/l, characterized in that it comprises
i) reacting a sewage sludge ash containing at least one iron compound and aluminium compound with at least one alkali metal chloride and/or at least one alkaline earth metal chloride at a temperature of 200° C. to 1100° C. in an inert gas atmosphere containing preferably less than 200 ppm of oxygen,
ii) withdrawing the formed iron chloride and aluminium chloride in the offgas stream and
iii) treating the obtained residue by addition of 0.1 to 5 mol of a mineral acid per mole of phosphate in the residue, preferably 0.2 to 1 mol of a mineral acid per mole of phosphate in the residue, to afford water-soluble phosphate compounds.

Suitable mineral acids in step iii) include for example sulfuric acid, hydrochloric acid, nitric acid and/or phosphoric acid, where phosphoric acid is preferably employed.

The residue of the reaction may thus be converted in step iii) into a water- and/or citric acid-soluble salt which is suitable as such for use in agriculture.

The preferred ranges for this process also apply to those described above.

### Reactor

The material to be used in the process according to the invention is preferably introduced into a reactor that has preferably been provided with a layer which is resistant under the reaction conditions to be established. Preferred reactor materials are nickel- or graphite-coated reactors. Reactors used may be tubular reactors such as rotary tube reactors or other reactors. Particular preference is given to reactors that allow movement of the material during the reaction in order to allow the most effective possible contacting of the reactants and heat distribution. Preference is given to fluidized bed apparatuses and rotary tube reactors, or a reaction in an extruder apparatus with screw propulsion.

In the case of a tubular reactor the reactor length is preferably 0.2 to 40 m. The residence time in the reactor during the reaction is generally a function of temperature and contact probability of the reactants with one another. The residence time in the reactor may extend, for example, from one minute to 5 hours. The process according to the invention may be conducted batchwise or continuously.

### EXAMPLES

### Analysis

After dissolution of the sewage sludge ash sample in suitable acids analysis was performed by ICP-OES after calibration for the particular element via calibrated standard solutions of the respective elements.

X-ray diffractograms (XRD) were recorded on powders (flatbed) at 2 theta angles between 0° and 60° at a wavelength of 0.154 nm.

### Example 1

6.8 g of sewage sludge ash (according to XRD contains iron-phosphorus compounds including Ca₉Fe(PO₄)₇, having the composition (in weight percent): 13% Fe, 1.5% Al, 6.8% Ca, 0.44% Mg, 21% PO₄³⁻, 0.52% Na) is mixed with 1.4 g of KCl, 3.6 g of MgCl₂ and 1.6 g of NaCl and then initially heated to 450° C. in a crucible open to an anhydrous atmosphere and held at this temperature for 4 h, then heated to 1000° C. and held for another 4 h. A weight loss of 21% brought about by the sublimation of iron chloride and aluminium chloride was determined.

In order to be able to utilize the residue as well the reaction time was extended, thus affording an iron-free residue that may be employed for use in agriculture.

The residue obtained shows characteristic reflections in the X-ray diffractogram at 32.3° 2Theta and 33.2° 2Theta (wavelength: 1.54060 angströms).

The residue obtained is admixed with 1.4 g of phosphoric acid to convert the magnesium phosphate formed and the calcium phosphate present into the water-soluble forms. The powder is subjected to granulation and has an iron and aluminium content which sums to less than 1% by weight, calculated as elements.

### Example 2

69 g of sewage sludge ash (according to XRD contains inter alia Ca₉Fe(PO₄)₇, having the composition (in weight percent) 13% Fe, 1.5% Al, 6.8% Ca, 0.44% Mg, 21% PO₄³⁻, 0.52% Na) are subjected to intimate dry mixing with 14 g of NaCl and 17 g of MgCl₂ (anhydrous). 56.2 g of the red mixture are filled into a quartz tube which is immediately purged with dry nitrogen to avoid absorption of water from the air. The quartz tube is placed in a tube furnace. A motor rotates the quartz tube around its own axis by about 200°/min in an oscillating motion during heating and the powder bed is therefore continuously in motion. Simultaneously a gas stream of 0.5 l/min of purified nitrogen (oxygen <200 ppm v/v) is passed through the tube and thus also over the sample. The tube outlet (=gas outlet) is narrowed by a loosely inserted piece of quartz wool.

The furnace and the sample in the quartz tube are heated to 1000° C. (20 K/min) while the gas stream and the oscillating rotating motion are maintained. After 120 minutes the test is terminated and the furnace and the sample are cooled to room temperature under further nitrogen flow. The originally red powder became white (47.2 g) while in the reactor outlet in the region above 200° C. a yellowish precipitate, and in the cooler region further removed from the furnace, at about 100° C., a white sublimate, were formed. A gas composed at least partially of HCl, as verified by gas phase infrared spectroscopy, was formed.

The white residue remaining in the tube (yield 47.2 g or 84%) is analysed. Based on the employed mixture only 41% of the Fe, 64% of the Al, 61% of the Mg and 72% of the Na were recovered.

In order to be able to utilize the residue as well the reaction time was extended, thus affording an iron-free and aluminium-free residue that may be employed for use in agriculture.

The amount of phosphorus and the amount of calcium in the sample are unchanged by the reaction. The residue obtained shows characteristic reflections in the X-ray diffractogram at 32.3° 2Theta and 33.2° 2Theta (wavelength: 1.54060 angströms).

The residue obtained is admixed with 50 g of an 85% phosphoric acid to convert the magnesium phosphate formed and the calcium phosphate present into the water-soluble forms. The thus obtained mixture may be used, optionally after granulation, for plant fertilizer.

The white resublimate obtained is aluminium chloride and the yellowish resublimate is iron chloride, both of which may be collected separately and both of which have a high purity.

### Example 3

6.8 g of sewage sludge ash (according to XRD contains inter alia Ca₉Fe(PO₄)₇, having the composition (in weight percent): 13% Fe, 1.5% Al, 6.8% Ca, 0.44% Mg, 21% PO₄³⁻, 0.52% Na) is mixed with 1.8 g of MgCl₂ and 3.2 g of KCl. The red mixture is filled into a quartz tube which is immediately purged with dry nitrogen to avoid absorption of water from the air. The quartz tube is placed into a tube furnace and adequately purged for half an hour with purified nitrogen (0.5 l/min, oxygen <200 ppm v/v). During the experiment and the temperature increase via the furnace heater the gas flow of 0.5 l/min of purified nitrogen (oxygen <200 ppm v/v) through the pipe and the sample is maintained. The empty pipe outlet (=gas outlet) protruding from the oven is furnaces maintained at 100° C. and the mixture in the glass tube is heated to 750° C. in the furnace.

The originally red powder became white while in the reactor outlet in the region above 200° C. a yellowish precipitate, and in the cooler region further removed from the furnace, at about 100° C., a white sublimate, were formed. The white sublimate obtained is aluminium chloride and the yellowish sublimate is iron chloride, both of which may be collected separately and both of which have a high purity.

The amount of phosphorus and the amount of calcium in the sample are unchanged by the reaction.

The residue obtained is admixed with 50 g of an 85% phosphoric acid to convert the magnesium phosphate formed and the calcium phosphate present into the water-soluble forms. The thus obtained mixture may be used, optionally after granulation, for plant fertilizer.

The likewise obtained sublimate may be reused for phosphate precipitation in sewage treatment works, optionally after purification to remove undesired heavy metals.

1. A process for producing iron chloride and aluminium chloride, the process comprises
i) reacting a sewage sludge ash containing at least one iron compound and aluminium compound with at least one alkali metal chloride and/or at least one alkaline earth metal chloride at a temperature of 200° C. to 1100° C. in an inert gas atmosphere and
ii) withdrawing and isolating the formed iron chloride and aluminium chloride in the offgas stream.

2. The process according to claim 1, characterized in that wherein the iron chloride is deposited from the offgas stream by resublimation in step il).

3. The process according to claim 1, characterized in that wherein the aluminium chloride is deposited from the offgas stream by resublimation in step ii).

4. The process according to claim 1, wherein the sewage sludge ash contains iron and aluminium compounds in an amount summing to 1.7% to 41.2% by weight calculated as the respective elemental metal.

5. The process according to claim 1, wherein the reaction is carried out with at least one alkali metal chloride and at least one alkaline earth metal chloride.

6. The process according to claim 1, wherein the reaction is carried out with sodium chloride and magnesium chloride.

7. The process according to claim 1, wherein the reaction is carried out with potassium chloride and magnesium chloride.

8. The process according to claim 1, wherein, as calculated for the respective element, the sewage sludge ash contains
calcium from 4% to 38% by weight,
potassium from 0% to 2% by weight,
magnesium from 0.1% to 4% by weight,
sodium from 0.1% to 4% by weight,
phosphate PO₄³⁻ 4% to 40% by weight,
sulfur from 0% to 7% by weight,
silicon from 0% to 24% by weight and
titanium from 0% to 2% by weight.

9. The process according to claim 1, wherein it employs a mixture of alkaline earth metal chlorides and alkali metal chloride in a weight ratio of 4:1 to 0.25:1, in particular from 2:1 to 0.5:1.

10. The process according to claim 1, wherein the molar ratio of chlorine from the employed alkali metal chlorides and alkaline earth metal chlorides to the sum of iron and aluminium present in the mixture, calculated as metal, is 1 to 6.

11. The process according to claim 1, wherein the reaction is carried out at a temperature of 400° C. to 1000° C.

12. A process for producing water-soluble phosphate compounds having a water solubility at 20° C. of greater than 1 g/l, wherein the process comprises
i) reacting a sewage sludge ash containing at least one iron compound and aluminium compound with at least one alkali metal chloride and/or at least one alkaline earth metal chloride at a temperature of 200° C. to 1100° C. in an inert gas atmosphere,
ii) withdrawing the formed iron chloride and aluminium chloride in the offgas stream and
iii) treating the obtained residue by addition of 0.1 to 5 mol of a mineral acid per mole of phosphate in the residue to afford water-soluble phosphate compounds.
